(19) United States
(12) Patent Application Publication
(10) Pub. No.: US 2015/0304483 A1
(43) Pub. Date: Oct. 22, 2015

(54) Bluetooth-Based Limitation of Functionality of Motor Vehicle Drivers' Personal Electronic Mobile Smart Devices During Driving

(71) Applicant: FIAT GROUP AUTOMOBILES S.P.A., Torino (IT)

(72) Inventor: Dario Dafre', Torino (IT)

(73) Assignee: FCA ITALY S.p.A., Torino (IT)

(21) Appl. No.: 14/440,823

(22) PCT Filed: Nov. 7, 2013
(86) PCT No.: PCT/IB2013/059982

§ 371 Date: May 5, 2015

(30) Foreign Application Priority Data
Nov. 7, 2012 (IT) TO2012A000973

(51) Int. Cl. H04M 1/725; H04W 4/02; H04W 4/00

(52) U.S. Cl. CPC H04M 1/72577; H04W 4/008; H04W 4/027

(57) ABSTRACT

A system for managing operation of a personal electronic mobile smart device when it is on board a motor vehicle; wherein the personal electronic mobile smart device and the motor vehicle are each provided with a Bluetooth-based short-range bidirectional wireless communication system operable to detect the presence of short-range bidirectional wireless communication systems within its communication range and to connect to the short-range bidirectional wireless communication systems detected within its communication range; and wherein the personal electronic mobile smart device is configured to implement a number of user-accessible functions and to automatically reconfigure access to its user-accessible functions when its short-range bidirectional wireless communication system is Bluetooth-connected to the short-range bidirectional wireless communication system of the motor vehicle.

### TECHNICAL FIELD OF INVENTION

The present invention refers in general to controlling the operation of personal electronic mobile smart devices on board motor vehicles to observe road safety regulations, and in particular to limiting the functionality of smart mobile communication devices such as smartphones or tablets of motor vehicle drivers during driving.

### STATE OF THE ART

As is known, for reasons of cost, the infotainment systems of motor vehicles are always equipped with limited resources and for this motive are subject to very rapid technological obsolescence, to the extent that when a new motor vehicle model is launched on the market, its infotainment system is often unable to support the latest technological developments.

However, this is not the case of personal electronic mobile smart devices, especially smart mobile communication devices such as smartphones or tablets, which, to the contrary, are increasingly more powerful and less expensive.

The increasingly widespread presence of these devices in our day-to-day life and the enormous availability of applications developed for them, also including many for the automotive environment, is effectively making them indispensable for our everyday life, to the point that ensuring their interaction with the infotainment systems of motor vehicles to make their functions available on board the vehicles as well, such as on and off-board satellite navigation, collision avoidance, sending and receiving voice SMS messages, video playback, Internet navigation, games, etc., was a forced-choice in the past and, today, is an indispensable function of motor vehicles.

An excellent example of these systems is represented by the Blue&Me™ infotainment system developed by the applicant, which is an infotainment system for communications and entertainment that offers Bluetooth connectivity, USB and a speakerphone kit that can be completely controlled by voice commands. In particular, the Blue&Me™ system enables the driver and passengers to use personal electronic mobile smart devices, such as mobile phones, palmtops, tablet computers, music players or external hard disks, without having to use the controls of these devices, so as to make them easier and less hazardous to use while driving.

To this end, the Blue&Me™ system is equipped with a voice recognition system that enables accessing most of the functions of the personal electronic mobile smart devices via voice commands or push-buttons on the motor vehicle's steering wheel. The exchange of data between these devices and the Blue&Me™ system usually takes place via a Bluetooth communication system, which is structured to connect these devices to the system platform.

Another example of these systems is represented by the cradles (passive supports) for personal electronic mobile smart devices, which can be of the type integrated in motor vehicle dashboards or of the type that can be inserted in a removable manner in special sockets provided on motor vehicle dashboards, such as those known as MyPort present on the motor vehicles manufactured by the applicant, thereby rendering the functions of these devices accessible within fingertip reach of the driver.

### SUBJECT AND ABSTRACT OF THE INVENTION

While utilization of the functions of personal electronic mobile smart devices must be complete when outside of motor vehicles, for obvious reasons of driving safety this clearly must not happen inside motor vehicles: the use of these devices by drivers would result in them being distracted from the primary driving task, thereby compromising motor vehicle driving safety and, in consequence, occupant safety.

The object of the present invention is providing a solution that enables controlling the operation of personal electronic mobile smart devices, in particular drivers' ones, to observe road safety regulations when they are inside motor vehicles.

This object is achieved by present invention in so far as it relates to a system for managing operation of a personal electronic mobile smart device when it is on board a motor vehicle, an automotive infotainment system, an automotive electronic control unit, software loadable in the automotive electronic control unit, a motor vehicle and a personal electronic mobile smart device, as defined in the appended claims.

### BRIEF DESCRIPTION OF DRAWINGS

The attached FIGURE is a block diagram of a system for managing operation of a personal electronic mobile smart device when it is on board a motor vehicle, according to the present invention.

### DETAILED DESCRIPTION OF PREFERRED EMBODIMENTS OF THE INVENTION

The present invention will now be described in detail with reference to the attached FIGURE to enable an expert in the field to embody it and use it. Various modifications to the described embodiments will be immediately obvious to experts in the field, and the generic principles described herein can be applied to other embodiments and applications without departing from the scope of the present invention, as defined in the appended claims. Thus, the present invention should not be considered as limited to the embodiments set forth herein, but is to be accorded the widest scope consistent with the principles and features disclosed and claimed herein.

The idea underlying the present invention is exploiting the Bluetooth technology which is on board many motor vehicles for managing the operation of those personal electronic mobile smart devices that are also based on this technology in order to ensure observance of road safety regulations.

The attached FIGURE schematically shows a system for managing operation of a personal electronic mobile smart device 1 when it is on board a motor vehicle 2, a smartphone in the example shown and to which the present description will make reference without any loss of generality.

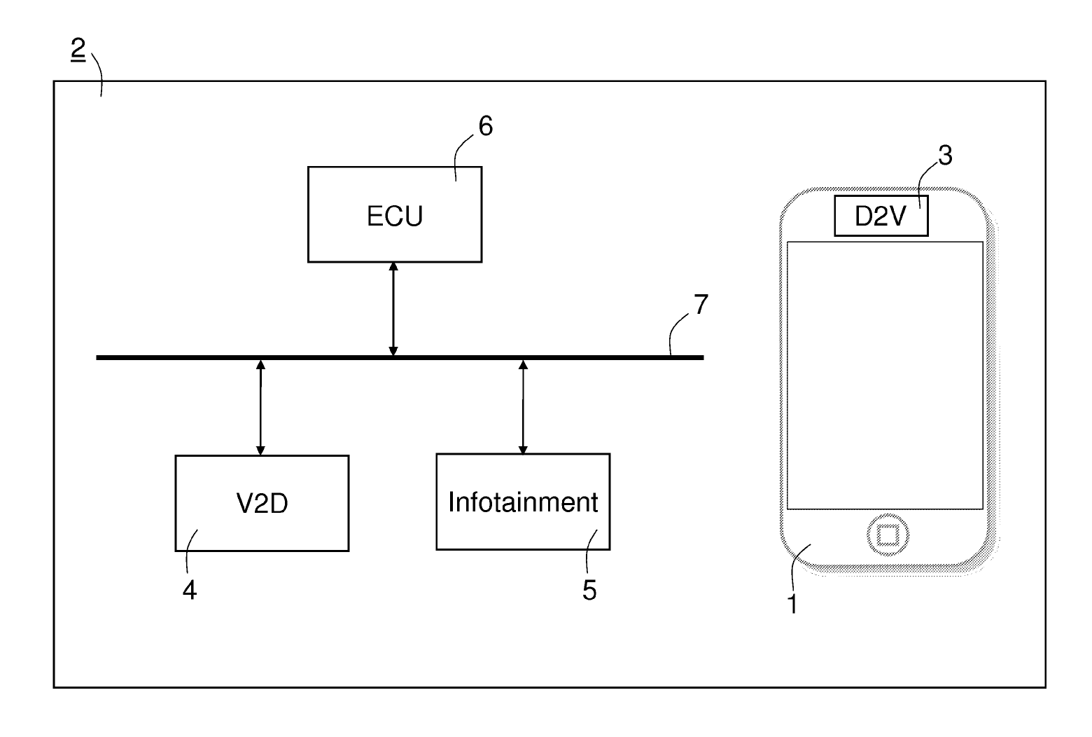

According to FIG. 1, the smartphone 1 and the motor vehicle 2 are each provided with a short-range bidirectional wireless communication system 3 and 4, hereinafter respectively abbreviated for convenience to ‘V2D’ (acronym for Vehicle-to-Device) and ‘D2V’ (acronym for Device-to-Vehicle) communication systems operable to detect the presence of other short-range bidirectional wireless communication systems within its communication range and to establish a connection with the short-range bidirectional wireless communication systems detected within its communication range.

The D2V and V2D communication systems 3 and 4 of the smartphone 1 and the motor vehicle 2 are based on Bluetooth technology, defined by a proprietary standard that is so well-known world-wide that it shall not be described in detail herein.

As is known, in order for the D2V and V2D communication systems 3 and 4 of the smartphone 1 and the motor vehicle 2 to connect to each other, Bluetooth technology requires that the D2V and V2D communication systems 3 and 4 have been previously paired. Through the pairing procedure, which is typically initiated by the V2D communication system 4 of the motor vehicle 2, the D2V and V2D communication systems 3 and 4 carry out mutual identification by exchanging and identifying an identification code in order to authorize data exchange.

Furthermore, although the D2V and V2D communication systems 3 and 4 can be paired to different D2V communication systems 3 of smartphones 1, they can only communicate with one short-range bidirectional wireless communication system at a time. For this reason, the V2D communication system 4 of the motor vehicle 2 consequently makes a first attempt at establishing a Bluetooth connection with the last, in order of time, paired D2V communication system 3 with which it was connected before the last disconnection, and, in the case where the search for this paired D2V communication system 3 fails, for example because it is switched off or not on board the motor vehicle 2, it runs through the other paired D2V communication systems 3 one at a time, always following the same rule.

Furthermore, according to a first, basic embodiment of the invention, the smartphone 1 is further programmed to automatically enter a so-called ‘Driving Mode’ operating mode when its D2V communication system 3 is Bluetooth-connected to the V2D communication system 4 of the motor vehicle 2, an operating mode in which the smartphone 1 automatically reconfigures access to its user-accessible functions.

In particular, the automatic reconfiguration of access to the user-accessible functions of the smartphone 1 can consist of a total limitation on access to the user-accessible functions, thereby effectively rendering the smartphone 1 on board the motor vehicle 2 unusable by the user, or can more conveniently consist of a partial limitation on access to the user-accessible functions, and in particular result in the possibility of accessing only the functions operatively inherent in, or logically related to, the motor vehicle driving, for example satellite navigation, collision avoidance signalling, lane-change signalling, etc., whilst blocking access to functions neither operatively inherent in, nor logically related to, the motor vehicle driving, which are typically those that would distract the driver the most from driving the motor vehicle 2, for example watching video clips, games, etc.

The features of the automatic reconfiguration of access to the user-accessible functions, such as the possibility of enabling and disabling the automatic reconfiguration and the user-accessible functions that are subject to limitation and those that are freely usable, could be programmed by the manufacturer of the smartphone 1, and therefore be beyond the control of the user, or could be programmable by the user, either directly on the smartphone 1 or via the graphical human-machine interface (HMI) of the infotainment system, indicated in FIG. 1 by reference numeral 5, of the motor vehicle 2, by exploiting the link between the smartphone 1 and the motor vehicle 2 via the D2V and V2D communication systems 3 and 4. The smartphone 1 or the infotainment system 5 of the motor vehicle 2 or both are thus programmed in this sense.

According to a different, more advanced embodiment of the invention, the automatic reconfiguration of access to the user-accessible functions of the smartphone 1 is performed by the smartphone 1 only if the motor vehicle 2 is determined to be moving, so as to ensure that utilization of the functions of the personal electronic mobile smart devices is total even inside the motor vehicle, on condition that it is stationary. In fact, in this situation the use of functions of the smartphone 1 neither operatively inherent in, nor logically related to, the motor vehicle driving can in no way distract from the primary driving task.

The conditions of whether the motor vehicle 2 is stationary or moving can be autonomously determined by the smartphone 1, in the case where it is equipped with a satellite navigation system, inertial sensors or another technology suitable for this purpose, or be determined and transmitted to the smartphone 1 by the motor vehicle 2.

In the latter case, again with reference to the attached FIGURE, the motor vehicle 2 is equipped with an electronic control unit 6 connected to an automotive on-board communication network, for example CAN, FlexRAy or others, schematically shown and indicated as a whole by reference numeral 7, to receive data indicating the current motor vehicle speed, measured by on-vehicle sensors, to determine, based on the received data, whether the motor vehicle 2 is stationary or moving based on the outcome of a comparison between the current motor vehicle speed and a programmable threshold speed and, finally, to cause the V2D communication system 4 of the motor vehicle 2 to transmit data indicating whether the motor vehicle 2 is stationary or moving to a short-range bidirectional wireless communication system paired to it, in this case only to the D2V communication system 3 of the smartphone 1.

The smartphone 1 is programmed to
acquire data indicating whether the motor vehicle 2 on which it is located is stationary or moving, received by its D2V communication system 3 and transmitted from the V2D communication system 4 of the motor vehicle 2, and
automatically reconfigure access to the user-accessible functions when its D2V communication system 3 is Bluetooth-connected to the V2D communication system 4 of the motor vehicle 2 and the motor vehicle 2 is determined to be moving.

As an alternative to that described above, instead of data indicating whether the motor vehicle 2 is stationary or moving, the electronic control unit 6 could cause the V2D communication system 4 of the motor vehicle 2 to directly transmit the received data indicating the current motor vehicle speed to the D2V communication system 3 of the smartphone 1. In this case, determining whether the motor vehicle 2 is stationary or moving is performed directly by the smartphone 1 in a manner similar to that described above with reference to the electronic control unit 6, in which the threshold speed above which access to the user-accessible functions is automatically reconfigured can be programmed by a user directly on the smartphone 1 or by the electronic control unit 6 using the link between the smartphone 1 and the motor vehicle 2 via the D2V and V2D communication systems 3 and 4.

According to a further, even more advanced embodiment of the invention, the smartphone 1 is further, programmed to cause the voice control mode of the smartphone 1 to be selected upon entering ‘Driving Mode’.

Finally, according to a further embodiment of the invention, the pairing between the D2V and V2D communication systems 3 and 4 of the smartphone 1 and the motor vehicle 2, as well as the exchange of data between these necessary for implementation of the present invention, could be carried out using a different communications technology from Bluetooth, conveniently NFC technology, acronym for Near Field Communication, which is a technology created for transaction validation, access authorization and holding a person's sensitive data that enables the secure exchange of data as its usability is limited to the proximity between the transmitting device and the receiving one, typically up to a maximum of 4 cm. It has been integrated into smart mobile communication devices, such as smartphones, and soon, in addition to the above-mentioned functions, it is also expected to use it for gaining access to and starting motor vehicles, and so its integration in smart mobile communication devices consequently leads to this technology being present inside motor vehicles.

In particular, NFC technology provides a short-range bidirectional wireless connectivity, in particular at radio frequency (RF), and typically up to a maximum of 10 cm, which technology, although characterized by low data transmission speeds, has low electrical power consumption.

NFC technology developed from a combination of contactless identification, in particular at radio frequency (Radio Frequency Identification—RFID), and other connectivity technologies. Unlike the simpler RFID devices, NFC technology enables bidirectional communication between two devices equipped with this type of technology, one known as the ‘initiator’ and the other known as the ‘target’, which, when placed within a radius of 4 cm of each other, cooperate to create a peer-to-peer network over which data can be sent and received.

NFC technology operates at a frequency of 13.56 MHz and can reach maximum transmission speeds of 424 kbit/s.

NFC technology can be directly implemented by an integrated chip or by using a special external card that exploits the SD or micro SD card ports.

More detailed information regarding this technology can, for example, be found at: http://en.wikipedia.org/wiki/Near_field_communication.

In consequence, this embodiment necessarily requires that, in addition to Bluetooth technology, both the V2D communication system 4 of the motor vehicle 2 and the D2V communication system 3 of the smartphone 1 are also based on NFC technology. Furthermore, the V2D communication system 4 of the motor vehicle 2 must be configured so as to be detected by the D2V communication system 3 of a smartphone 1 only when it is either at or in an area around the motor vehicle driver's seat 2 within reach of the driver of the motor vehicle 2, and not by the D2V communication systems of smartphones located outside this area.

This objective can be achieved in different ways. A first method is that of placing the antenna, hereinafter indicated by the term ‘NFC antenna’ for brevity, of the V2D communication system 4 of the motor vehicle 2, at the driver's seat, for example immediately beneath or at the side of the driver's seat, for example on the tunnel that separates the driver's seat from that of the passenger next to the driver, or in the armrest, if provided, of the driver's seat, or even actually inside the driver's seat.

Instead, in the case where the V2D communication system 4 of the motor vehicle 2 is configured so as to allow the driver to use his/her smartphone 1 to gain access to the motor vehicle 2 and start the internal combustion engine, a different way of reaching the above-stated objective could be that of exploiting the NFC antenna already present on the motor vehicle 2 to implement this functionality, which is usually located in the front door on the driver's side of the motor vehicle 2, close to the lock.

Instead, in the case where a cradle for a smartphone is provided on the dashboard of the motor vehicle 2, a further method for achieving the above-stated objective could be that of associating the NFC antenna of the V2D communication system of the motor vehicle 2 with the cradle, conveniently integrating it therein, whether the cradle is of the type integrated in the dashboard or of the type that can inserted in a removable manner in a special socket provided on the dashboard, so that the presence of the V2D communication system 4 of the motor vehicle 2 will be detected by the D2V communication system 3 of the driver's smartphone 1 the moment it is placed on the cradle.

Notwithstanding this, in this embodiment of the invention, the automatic reconfiguration of access to the user-accessible functions still continues to depend on the fact of whether or not the D2V communication system 3 of the smartphone 1 is Bluetooth-connected to the V2D communication system 4 of the motor vehicle 2, and, where relevant, the fact of whether or not the motor vehicle 2 is movement.

1. A system for managing operation of a personal electronic mobile smart device (1) when it is on board a motor vehicle (2);
wherein the personal electronic mobile smart device (1) and the motor vehicle (2) are each provided with a Bluetooth-based short-range bidirectional wireless communication system (3, 4) operable to detect the presence of short-range bidirectional wireless communication systems within its communication range and to connect to the short-range bidirectional wireless communication systems detected within its communication range; and wherein the personal electronic mobile smart device (1) is configured to implement a number of user-accessible functions and to automatically reconfigure access to the user-accessible functions when its short-range bidirectional wireless communication system (3) is Bluetooth-connected to the short-range bidirectional wireless communication system (4) of the motor vehicle (2).

2. A system according to claim 1, wherein the personal electronic mobile smart device (1) is configured to automatically reconfigure the access to the user-accessible functions by enabling access to user-accessible functions that are either operatively inherent in, or logically related to, the motor vehicle driving, and disabling access to the user-accessible functions that are neither operatively inherent in, nor logically related to, the motor vehicle driving.

3. A system according to claim 1 or 2, wherein the personal electronic mobile smart device (1) is further configured to allow a user to configure features of the automatic reconfiguration of access to user-accessible functions via either the personal electronic mobile smart device (1) or an infotainment system (5) of the motor vehicle (2).

4. A system according to any one of the preceding claims, wherein the personal electronic mobile smart device (1) is further configured to automatically reconfigure access to the user-accessible functions when the motor vehicle (2) is determined to be moving.

5. A system according to claim 4, wherein the personal electronic mobile smart device (1) is further configured either to autonomously determine whether the motor vehicle (2) is stationary or moving, or to receive via its short-range bidirectional wireless communication system (3) data indicating whether the motor vehicle (2) is stationary or moving.

6. A system according to claim 5, wherein the motor vehicle (2) comprises an electronic control unit (5) configured to receive data indicating the motor vehicle speed and to cause the short-range bidirectional wireless communication system (4) of the motor vehicle (2) to transmit data indicating whether the motor vehicle (2) is stationary or moving.

7. A system according to claim 6, wherein the electronic control unit (5) is configured to determine, based on the received data, whether the motor vehicle (2) is stationary or moving based on the outcome of a comparison between the current motor vehicle speed and a threshold speed.

8. A system according to claim 6, wherein the electronic control unit (5) is configured to cause the short-range bidirectional wireless communication system (4) of the motor vehicle (2) to transmit data indicating the current motor vehicle speed;
and wherein the personal electronic mobile smart device (1) is configured to receive, via its short-range bidirectional wireless communication system (3), data indicating the current motor vehicle speed and to determine, based on the received data, whether the motor vehicle (2) is stationary or moving based on the outcome of a comparison between the current motor vehicle speed and a threshold speed.

9. An automotive infotainment system (5) comprising a Bluetooth-based short-range bidirectional wireless communication system (4) configured to detect the presence of Bluetooth-based short-range bidirectional wireless communication systems within its communication range and to connect to the short-range bidirectional wireless communication systems detected within its communication range; wherein the automotive infotainment system is configured to allow a user to configure features of an automatic reconfiguration of access to user-accessible functions of the personal electronic mobile smart device (1) via a graphical human-machine interface and the short-range bidirectional wireless communication system (4).

10. An automotive infotainment system according to claim 9, further comprising an electronic control unit (6) connected to the short-range bidirectional wireless communication system (4) and configured to receive data indicating the motor vehicle speed and to cause the short-range bidirectional wireless communication system (4) to transmit data indicating whether the motor vehicle is stationary or moving to short-range bidirectional wireless communication systems detected within its communication range.

11. An automotive infotainment system according to claim 10, wherein the electronic control unit (5) is further configured to determine, based on the received data, whether the motor vehicle (2) is stationary or moving based on the outcome of a comparison between the current motor vehicle speed and a threshold speed, or to cause its short-range bidirectional wireless communication system (4) to transmit data indicating the current motor vehicle speed.

12. A motor vehicle (2) comprising an infotainment system according to any one of claims 9 to 11.

13. An automotive electronic control unit (6) for a motor vehicle (2) equipped with a Bluetooth-based short-range bidirectional wireless communication system (4) configured to detect the presence of Bluetooth-based short-range bidirectional wireless communication systems within its communication range and to connect to the short-range bidirectional wireless communication systems detected within its communication range; wherein the automotive electronic control unit (6) is configured to be connected to the short-range bidirectional wireless communication system (4) of the motor vehicle (2) to receive data indicating the motor vehicle speed and to cause the short-range-bidirectional wireless communication system (4) to transmit data indicating whether the motor vehicle is stationary or moving to short-range bidirectional wireless communication systems detected within its communication range.

14. An automotive electronic control unit (6) according to claim 13, further configured to determine, based on the received data, whether the motor vehicle (2) is stationary or moving based on the outcome of a comparison between the current motor vehicle speed and a threshold speed, or to cause its short-range bidirectional wireless communication system (4) to transmit data indicating the current motor vehicle speed.

15. Software loadable in an automotive electronic control unit (6) and designed to cause, when executed, the automotive electronic control unit (6) to become configured as claimed in claim 13 or 14.

16. A personal electronic mobile smart device (1) configured as claimed in any one of claims 1-5 and 8.
